(19) United States
(12) Patent Application Publication
(10) Pub. No.: US 2015/0254656 A1
(43) Pub. Date: Sep. 10, 2015

(54) ACCOUNT TOKEN ASSOCIATIONS BASED ON SPENDING THRESHOLDS

(71) Applicant: Bank of America Corporation, Charlotte, NC (US)

(72) Inventors: Laura Corinne Bondesen, Charlotte, NC (US); Jason P. Blackhurst, Charlotte, NC (US); Scott Lee Harkey, Concord, NC (US); William Blakely Belchee, Charlotte, NC (US); Tammy L. Brunswig, Fort Mill, SC (US)

(73) Assignee: Bank of America Corporation, Charlotte, NC (US)

(21) Appl. No.: 14/196,350

(22) Filed: Mar. 4, 2014

(51) Int. Cl. G06Q 20/40; G06Q 20/36; G06Q 20/10; G06Q 20/22

(52) U.S. Cl. CPC G06Q 20/40; G06Q 20/227; G06Q 20/36; G06Q 20/10

(57) ABSTRACT

Embodiments for providing token-account associations based on spending thresholds include systems and methods for generating tokens and associating the tokens with an account. The systems set parameters for the token, where the token parameters include at least a transaction amount maximum. The systems further receive transaction data associated with the transaction and compare the transaction data with the token parameters.

### BACKGROUND

Consumer transactions using traditional transaction channels may be susceptible to security concerns. The use of credit cards for making purchases, for example, involves the exchange of personal and account information among several parties to the transaction. The processing of such payments may lead to misappropriations due to the way in which sensitive information is exposed.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The embodiments are directed to systems for providing token-account associations. The systems include a computer apparatus including a processor and a memory and a software module stored in the memory, comprising executable instructions that when executed by the processor cause the processor to receive a token request from a user. In some embodiments, the executable instructions further cause the processor to generate a token.

In some embodiments, the executable instructions further cause the processor to associate the token with a first account. In some embodiments, the executable instructions further cause the processor to set parameters for the token, the token parameters comprising at least a transaction amount maximum. In some embodiments, the executable instructions further cause the processor to allow the user to select the token for a transaction. In some embodiments, the executable instructions further cause the processor to receive transaction data associated with the transaction. In some embodiments, the executable instructions further cause the processor to compare the transaction data with the token parameters.

In additional embodiments of the systems, the executable instructions further cause the processor to determine that the transaction amount is above the transaction amount maximum. In other embodiments, the executable instructions further cause the processor to switch the association of the token from the first account to a second account. In still other embodiments, the first account and the second account are different types of accounts. In further embodiments, the executable instructions further cause the processor to determine that the transaction amount is below the transaction amount maximum based on the comparison, authenticate the token, process the transaction.

In some embodiments, the executable instructions further cause the processor to recommend an alternate token or payment channel to the user. In other embodiments, the executable instructions further cause the processor to allow the user to select a second token for the transaction. In still other embodiments, the executable instructions further cause the processor to identify items corresponding to the product codes; calculate a total amount for the identified items; and determine whether the total amount is above or below the transaction amount maximum. In additional embodiments, the transaction amount maximum is based on at least one of user preferences, a spending category, or a type of account. In still more embodiments, the executable instructions further cause the processor to associate the token with a mobile wallet application. In some embodiments, the token is a single-use instrument or a multi-use instrument.

Also provided are embodiments directed to computer program products for providing token-account associations. The computer program products include a non-transitory computer readable storage medium having computer readable program code embodied therewith, the computer readable program code comprising computer readable program code configured to receive a token request from a user. In some embodiments, the computer program products further include computer readable program code configured to generate a token. In some embodiments, the computer program products further include computer readable program code configured to associate the token with a first account. In some embodiments, the computer program products further include computer readable program code configured to set parameters for the token, the token parameters comprising at least a transaction amount maximum. In some embodiments, the computer program products further include computer readable program code configured to allow the user to select the token for a transaction. In some embodiments, the computer program products further include computer readable program code configured to receive transaction data associated with the transaction. In some embodiments, the computer program products further include computer readable program code configured to compare the transaction data with the token parameters.

In further embodiments, the computer program products further include comprising computer readable program code configured to determine that the transaction amount is above the transaction amount maximum. In some embodiments, the computer program products further include computer readable program code configured to switch the association of the token from the first account to a second account. In other embodiments, the computer program products further include computer readable program code configured to identify items corresponding to the product codes; calculate a total amount for the identified items; and determine whether the total amount is above or below the transaction amount maximum. In still other embodiments, the computer program products further include computer readable program code configured to associate the token with a mobile wallet application.

Further provided herein are computer-implemented methods for providing token-account associations. In some embodiments, the methods include receiving a token request from a user. In some embodiments, the methods include generating, by a processor, a token. In some embodiments, the methods include associating, by a processor, the token with a first account. In some embodiments, the methods include setting, by a processor, parameters for the token, the token parameters comprising at least a transaction amount maximum. In some embodiments, the methods include allowing, by a processor, the user to select the token for a transaction. In some embodiments, the methods include receiving, by a processor, transaction data associated with the transaction. In some embodiments, the methods include comparing, by a processor, the transaction data with the token parameters.

In some embodiments, the methods include determining, by a processor, that the transaction amount is above the transaction amount maximum. In some embodiments, the methods include switching, by a processor, the association of the token from the first account to a second account. In some embodiments, the methods include recommending, by a processor, an alternate token or payment channel to the user.

Other aspects and features, as recited by the claims, will become apparent to those skilled in the art upon review of the following non-limited detailed description of the invention in conjunction with the accompanying figures.

### BRIEF DESCRIPTION OF THE SEVERAL VIEWS OF THE DRAWINGS

The present embodiments are further described in the detailed description which follows in reference to the noted plurality of drawings by way of non-limiting examples of the present embodiments in which like reference numerals represent similar parts throughout the several views of the drawings and wherein:

FIG. 1A provides a block diagram illustrating a system and environment for providing tokens in accordance with the embodiments presented herein;

FIG. 1B provides a block diagram illustrating a system and environment for providing tokens in accordance with the embodiments presented herein;

FIG. 1C provides a block diagram illustrating a system and environment for providing tokens in accordance with the embodiments presented herein;

FIG. 2 provides a block diagram illustrating the systems of FIG. 1, in accordance with various embodiments;

FIG. 3 is a flowchart illustrating a system and method for providing flexible funding of tokens in accordance with various embodiments;

FIG. 4 is a flowchart illustrating a system and method for providing flexible funding of tokens in accordance with various embodiments; and

FIG. 5 is a flowchart illustrating a system and method for providing flexible funding of tokens in accordance with various embodiments.

### DETAILED DESCRIPTION

The embodiments presented herein are directed to systems, methods, and computer program products for providing, managing, funding, and processing tokens. The systems and methods generate tokens and associate the tokens with one or more account and/or digital wallets. In some embodiments, the token-account associations are switched in response to various token parameters, including codes, permissions, and transaction amount maximums. The token systems described herein promote security by limiting data exposure and allow the user to adopt and swap funding sources as the need arise.

The embodiments of the disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present embodiments of the disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present embodiments of the disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present embodiments of the disclosure are described below with reference to flowchart illustrations and/or block diagrams of methods, apparatus (systems) and computer program products according to embodiments of the embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The present embodiments relate to tokenization, which is generally described in the area of financial transactions as utilizing a “token” (e.g., an alias, substitute, surrogate, or other like identifier) as a replacement for sensitive account information, and in particular account numbers. As such, tokens or portions of tokens may be used as a stand in for a user account number, user name, pin number, routing information related to the financial institution associated with the account, security code, or other like information relating to the user account. The one or more tokens may then be utilized as a payment instrument to complete a transaction. The one or more tokens may be associated with one or more payment devices directly or within one or more digital wallets associated with the payment devices. In other embodiments, the tokens may be associated with electronic transactions that are made over the Internet instead of using a physical payment device. Utilizing a token as a payment instrument instead of actual account information, and specifically an account number, improves security, and provides flexibility and convenience in controlling the transactions, controlling accounts used for the transactions, and sharing transactions between various users.

Tokens may be single-use instruments or multi-use instruments depending on the types of controls (e.g., limits) initiated for the token, and the transactions in which the token is used as a payment instrument. Single-use tokens may be utilized once, and thereafter disappear, are replaced, or are erased, while multi-use tokens may be utilized more than once before they disappear, are replaced, or are erased.

Tokens may be 16-digit numbers (e.g., like credit, debit, or other like account numbers), may be numbers that are less than 16-digits, or may contain a combination of numbers, symbols, letters, or the like, and be more than, less than, or equal to 16-characters. In some embodiments, the tokens may have to be 16-characters or less in order to be compatible with the standard processing systems between merchants, acquiring financial institutions (e.g., merchant financial institution), card association networks (e.g., card processing companies), issuing financial institutions (e.g., user financial institution), or the like, which are used to request authorization, and approve or deny transactions entered into between a merchant (e.g., a specific business or individual user) and a user. In other embodiments of the invention, the tokens may be other types of electronic information (e.g., pictures, codes, or the like) that could be used to enter into a transaction instead of, or in addition to, using a string of characters (e.g., numbered character strings, alphanumeric character strings, symbolic character strings, combinations thereof, or the like).

A user may have one or more digital wallets on the user's payment device. The digital wallets may be associated specifically with the user's financial institution, or in other embodiments may be associated with a specific merchant, group of merchants, or other third parties. The user may associate one or more user accounts (e.g., from the same institution or from multiple institutions) with the one or more digital wallets. In some embodiments, instead of the digital wallet storing the specific account number associated with the user account, the digital wallet may store a token or allow access to a token (e.g., provide a link or information that directs a system to a location of a token), in order to represent the specific account number during a transaction. In other embodiments of the invention, the digital wallet may store some or all of the user account information (e.g., account number, user name, pin number, or the like), including the user account number, but presents the one or more tokens instead of the user account information when entering into a transaction with a merchant. The merchant may be a business, a person that is selling a good or service (hereinafter “product”), or any other institution or individual with which the user is entering into a transaction.

The digital wallet may be utilized in a number of different ways. For example, the digital wallet may be a device digital wallet, a cloud digital wallet, an e-commerce digital wallet, or another type of digital wallet. In the case of a device digital wallet the tokens are actually stored on the payment device. When the device digital wallet is used in a transaction the token stored on the device is used to enter into the transaction with the merchant. With respect to a cloud digital wallet the device does not store the token, but instead the token is stored in the cloud of the provider of the digital wallet (or another third party). When the user enters into a transaction with a merchant, transaction information is collected and provided to the owner of the cloud to determine the token, and thus, how the transaction should be processed. In the case of an e-commerce digital wallet, a transaction is entered into over the Internet and not through a point of sale terminal. As was the case with the cloud digital wallet, when entering into a transaction with the merchant over the Internet the transaction information may be captured and transferred to the wallet provider (e.g., in some embodiments this may be the merchant or another third party that stores the token), and the transaction may be processed accordingly.

Specific tokens, in some embodiments, may be tied to a single user account, but in other embodiments, may be tied to multiple user accounts, as will be described throughout this application. In some embodiments a single tokens could represent multiple accounts, such that when entering into a transaction the user may select the token (or digital wallet associated with the token) and select one of the one or more accounts associated with the token in order to allocate the transaction to a specific account. In still other embodiments, after selection of the token by the user the system may determine the best account associated with the token to use during the transaction (e.g., most cash back, most rewards points, best discount, or the like). In addition, the tokens may be associated with a specific digital wallet or multiple digital wallets as desired by the institutions or users.

Moreover, the tokens themselves, or the user accounts, individual users, digital wallets, or the like associated with the tokens, may have limitations that limit the transactions that the users may enter into using the tokens. The limitations may include, limiting the transactions of the user to a single merchant, a group of multiple merchants, merchant categories, single products, a group a products, product categories, transaction amounts, transaction numbers, geographic locations, or other like limits as is described herein.

While the system may determine whether the transaction meets the limits and either allowing or denying a transaction based on that determination, in some embodiments the filters may also be responsive to transaction information. For example, exceptions to the filters may allow a transaction even if the filter is not met. In an embodiment, the system evaluates the transaction information to determine: (1) does the transaction meet the limits; and (2) if the transaction does not meet the limits, does the transaction qualify for an exception to the limits. If the system determines that a positive response to either query, then transaction may be allowed.

In some embodiments, the exceptions are based at least in part upon the transaction information. For example, the system may determine that a transaction does not meet a category limit because doing so would cause the token to exceed the category limit for the time period. In this example, however, the system also determines that the token is near, e.g., within one week, within three days, within one day, or the like, the expiration date of the token or the current evaluation period for the token and that the token has remaining funds in a different category. Given the short period of time remaining for the expenses to be made, the system may determine that the transaction falls within an exception and allow the transaction. In another example, the system may determine that the user is outside of geographic limits defined by a route. The system, however, determines that the user has conducted a transaction at the merchant frequently in the past and therefore allows the transaction based on the previous number of transactions at the merchant. These examples use multiple types of transaction information, e.g., the date of the transaction, the location of the transaction, the category of the transaction, the amount of the transaction, and the like, to determine if the exceptions apply. In some embodiments, only a single piece of transaction information applies. For example, the system may always permit transactions that are associated with a specific category, for example, emergency expenses. The system may always permit transactions at emergency rooms, doctors' offices, and the like.

In some embodiments, the exceptions are determined by the system and/or the user. For example, the system may provide a list of exceptions based on the user's transaction history. If the user has a favorite coffee shop, the system may allow transactions at the coffee shop up to a certain amount even if the transaction would not meet a limit. The user or an administrator may provide exceptions based on location or other transaction information. For example, the user may input exceptions that allow transactions within a specific region, e.g., a city, that would not be allowed outside of the specific region. The exceptions may be changed at any time by the system or user.

The exceptions may be limited by frequency, amount, percentage of the limit, or the like. For example, a transaction may qualify for an exception but only up to a certain percentage of the funds remaining in a related category. For example, a transaction may qualify for an exception because the expense period for the token is almost expired and there are remaining funds in a first category. The system may permit a transaction in a second category up to some percentage (e.g., 50%) of the funds remaining in the first category.

The transaction-responsive limits are designed to provide flexibility to the system and better serve the user. The transaction-responsive limits may be tailored to the user or generic to the token and/or system. By providing for transaction-responsive limits, the system allows transactions that would otherwise be denied based on binary yes/no limits when the transaction information indicates the appropriateness of the transaction.

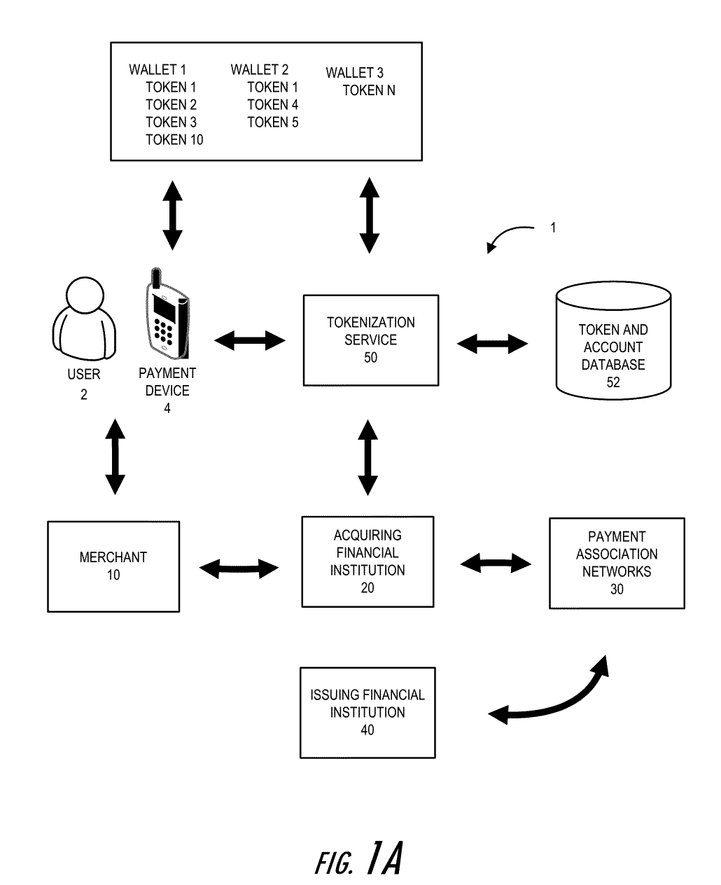

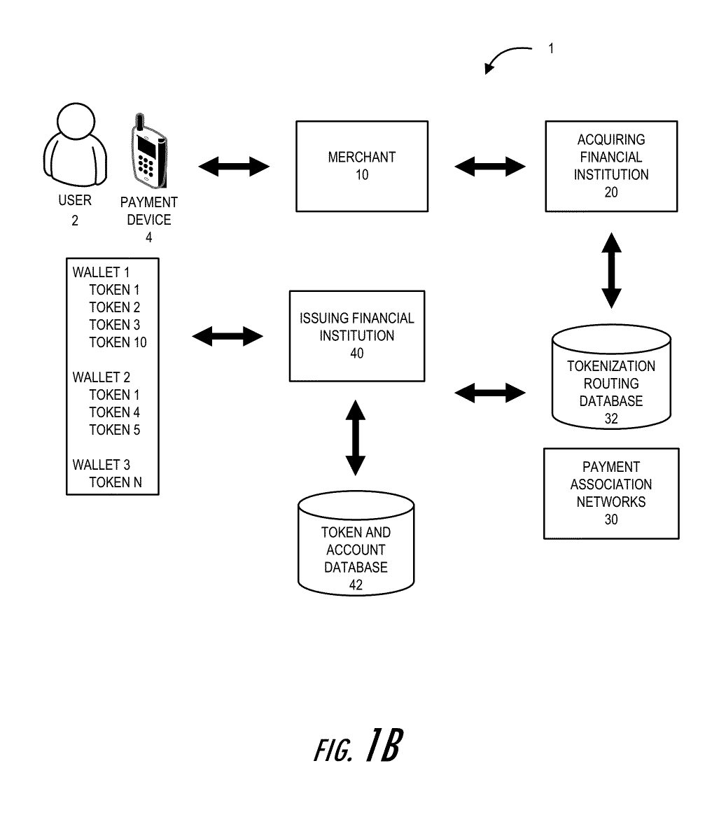

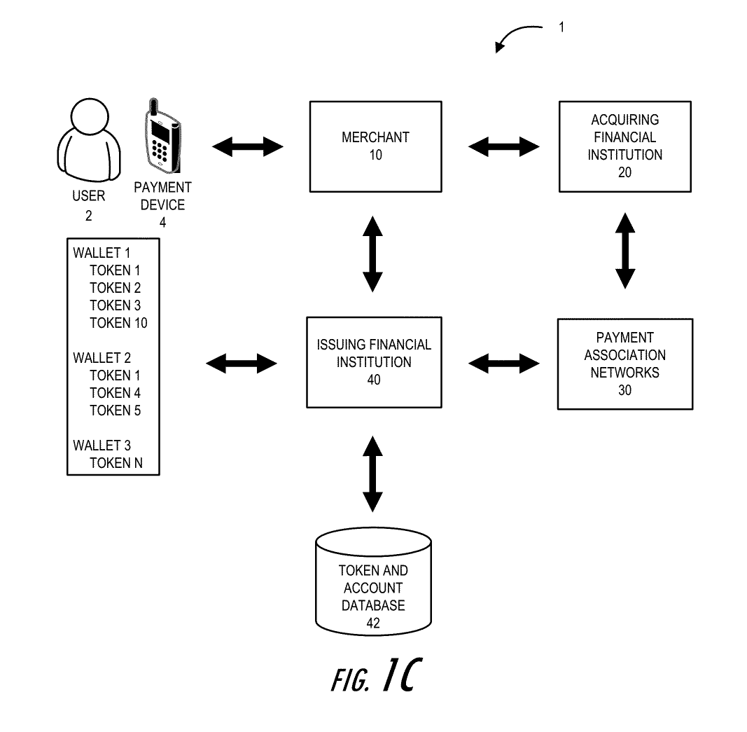

FIGS. 1A through 1C illustrate a number of different ways that the user 2 may use one or more tokens in order to enter into a transaction, as well as how the parties associated with the transaction may process the transaction. FIG. 1A illustrates one embodiment of a token system process 1, wherein the token system process 1 is used in association with a tokenization service 50. The tokenization service 50 may be provided by a third-party institution, the user's financial institution, or another institution involved in a transaction payment process. As illustrated in FIG. 1A (as well as in FIGS. 1B and 1C), a user 2 may utilize a payment device 4 (or in other embodiments a payment instrument over the Internet) to enter into a transaction. FIG. 1A illustrates the payment device 4 as a mobile device, such as a smartphone, personal digital assistant, or other like mobile payment device. Other types of payment devices 4 may be used to make payments, such as but not limited to an electronic payment card, key fob, a wearable payment device (e.g., watch, glasses, or the like), or other like payment devices 4. As such, when using a payment device 4 the transaction may be made between the point of sale (POS) and the payment device 4 by scanning information from the payment device 4, using near field communication (NFC) between the POS and the payment device 4, using wireless communication between the POS and the payment device 4, or using another other type of communication between the POS and the payment device 4. When entering into an e-commerce transaction over the Internet, for example using the payment device 4 or another device without a POS, a payment instrument (e.g., a payment application that stores the token) may be used to enter into the transaction. The payment instrument may be the same as the token or digital wallet associated with the payment device 4, except they are not associated with specific payment device. For example, the token or digital wallet may be associated with a payment application that can be used regardless the device being used to enter into the transaction over the Internet.

The token can be associated directly with the payment device 4, or otherwise, through one or more digital wallets associated with the payment device 4. For example, the token may be stored on one or more payment devices 4 directly, and as such any transaction entered into by the user 2 with the one or more payment devices 4 may utilize the token. Alternatively, the payment device 4 may have one or more digital wallets stored on the payment device 4 that allow the user 2 to store one or more user account numbers, or tokens associated with the user account numbers, on the one or more digital wallets. The user may select a digital wallet or account within the digital wallet in order to enter into a transaction using a specific type of customer account. As such, the digital wallets may be associated with the user's issuing financial institutions 40, other financial institutions, merchants 10 with which the user enters into transactions, or a third party institutions that facilitates transactions between users 2 and merchants 10.

As illustrated in FIG. 1A, a tokenization service 50 may be available for the user 2 to use during transactions. As such, before entering into a transaction, the user 2 may generate (e.g., create, request, or the like) a token in order to make a payment using the tokenization service 50, and in response the tokenization service 50 provides a token to the user and stores an association between the token and the user account number in a secure token and account database 52. The token may be stored in the user's payment device 4 (e.g., on the digital wallet) or stored on the cloud or other service through the tokenization service 50. The tokenization service 50 may also store limits (e.g., geographic limits, transaction amount limits, merchant limits, product limits, any other limit described herein, or the like) associated with the token that may limit the transactions in which the user 2 may enter. The limits may be placed on the token by the user 2, or another entity (e.g., client, administrator, person, company, or the like) responsible for the transactions entered into by the user 2 using the account associated with the token. The generation of the token may occur at the time of the transaction or well in advance of the transaction, as a one-time use token or multi-use token.

After or during creation of the token the user 2 enters into a transaction with a merchant 10 using the payment device 4 (or payment instrument over the Internet). In some embodiments the user 2 may use the payment device 4 by itself, or specifically select a digital wallet or user account stored within the digital wallet, to use in order to enter into the transaction. The token associated with payment device, digital wallet, or user account within the wallet is presented to the merchant 10 as payment in lieu of the actual user account number and/or other user account information. The merchant 10 receives the token, multiple tokens, and/or additional user account information for the transaction. The merchant 10 may or may not know that the token being presented for the transaction is a substitute for a user account number or other user account information. The merchant also captures transaction information (e.g., merchant, merchant location, transaction amount, product, or the like) related to the transaction in which the user 2 is entering with the merchant 10.

The merchant 10 submits the token (as well as any user account information not substituted by a token) and the transaction information for authorization along the normal processing channels (also described as processing rails), which are normally used to process a transaction made by the user 2 using a user account number. In one embodiment of the invention the acquiring financial institution 20, or any other institution used to process transactions from the merchant 10, receives the token, user account information, and transaction information from the merchant 10. The acquiring financial institution 20 identifies the token as being associated with a particular tokenization service 50 through the token itself or user account information associated with the token. For example, the identification of the tokenization service 50 may be made through a sub-set of characters associated with the token, a routing number associated with the token, other information associated with the token (e.g., tokenization service name), or the like. The acquiring financial institution 20 may communicate with the tokenization service 50 in order to determine the user account number associated with the token. The tokenization service 50 may receive the token and transaction data from the acquiring financial institution 20, and in response, provide the acquiring financial institution 20 the user account number associated with the token as well as other user information that may be needed to complete the transaction (e.g., user name, issuing financial institution routing number, user account number security codes, pin number, or the like). In other embodiments, if limits have been placed on the token, the tokenization service 50 may determine whether or not the transaction information meets the limits and either allows or denies the transaction (e.g., provides the user account number or fails to provide the user account number). The embodiment being described occurs when the token is actually stored on the payment device 4. In other embodiments, for example, when the actual token is stored in a cloud the payment device 4 may only store a link to the token or other token information that allows the merchant 10 or acquiring financial institution to acquire the token from a stored cloud location.

If the acquiring financial institution 20 receives the user account number from the tokenization service 50 (e.g., the tokenization service indicates that the transaction meets the limits), then the acquiring financial institution 20 thereafter sends the user account number, the other user information, and the transaction information directly to the issuing financial institution 40, or otherwise indirectly through the card association networks 30. The issuing financial institution 40 determines if the user 2 has the funds available to enter into the transaction, and if the transaction meets other limits on the user account, and responds with approval or denial of the transaction. The approval runs back through the processing channels until the acquiring financial institution 20 provides approval or denial of the transaction to the merchant 10 and the transaction between the merchant 10 and the user 2 is completed. After the transaction is completed the token may be deleted, erased, or the like if it is a single-use token, or stored for further use if it is a multi-use token.

Instead of the process described above, in which the acquiring financial institution 20 requests the token from the tokenization service 50, in some embodiments the tokenization service 50 may receive the transaction request and transaction information from the merchant 10 or acquiring financial institution 20. Instead of providing the account number to the acquiring financial institution 20, the tokenization service 50 may send the transaction request and transaction information to the issuing financial institution 40 directly, or indirectly through the payment association networks 30.

The embodiment illustrated in FIG. 1A prevents the user account number and other user information from being presented to the merchant 10; however, the tokenization service 50, acquiring financial institution 20, the card association networks 30, and the issuing financial institution 40 may all utilize the actual user account number and other user information to complete the transaction.

FIG. 1B illustrates another embodiment of a token system process 1, in which the user 2 may utilize a payment device 4 (or payment instrument over the Internet) to enter into transactions with merchants 10 utilizing tokens instead of user account numbers. As illustrated in FIG. 1B, the user may have one or more tokens, which may be associated with the payment device 4, one or more digital wallets within the payment device 4, or one or more user accounts associated with the digital wallets. The one or more tokens may be stored in the user's payment device 4 (or on the digital wallet), or stored on a cloud or other service through the issuing financial institution 40 or another institution. The user 2 may set up the digital wallet by communicating with the issuing financial institution 40 (e.g., the user's financial institution) to request a token for the payment device, either for the device itself, or for one or more digital wallets or one or more user accounts stored on the payment device. As previously discussed, a wallet may be specifically associated with a particular merchant (e.g., received from the merchant 10) and include one or more tokens provided by the issuing financial institution 40 directly (or through the merchant as described with respect to FIG. 1C). In other embodiments, the issuing financial institution 40 may create the digital wallet for the user 2 (e.g., through a wallet created for a business client or retail client associated with the user 2) and include one or more tokens for various types of transactions, products, or the like. The issuing financial institution 40 may store the tokens, the associated user account information (e.g., including the user account number), and any limits on the use of the tokens, as was previously described with respect to the tokenization service 50 in FIG. 1A. In one embodiment the tokens may include user account information or routing information within the token or tied to the token, which allows the merchants 10 and other institutions in the payment processing systems to route the token and the transaction information to the proper institutions for processing. In other embodiments a tokenization routing database 32 may be utilized to determine where to route a transaction using a token, as described in further detail later.

The user 2 may enter into a transaction with the merchant 10 using a payment device 4 (or a payment instrument through the Internet). In one embodiment the user 2 may enter into the transaction with a token associated with the payment device 4 itself (or a payment instrument through the Internet). In other embodiments, a specific digital wallet and/or a specific account within the digital wallet may be selected for a particular merchant with whom the user 2 wants to enter into a transaction. For example, the user 2 may select “wallet 1” to enter into a transaction with “merchant 1” and “token 1” to utilize a specific account. The merchant 10 identifies the token, and sends the token and the transaction information to the acquiring financial institution 20. If the token has routing information the acquiring financial institution 20 may route the token and transaction data to the issuing financial institution 40 directly or through the card association networks 30. In situations where the token does not have associated routing information, the acquiring financial institution 20 may utilize a tokenization routing database 32 that stores tokens or groups of tokens and indicates to which issuing financial institutions 40 the tokens should be routed. One or more of the acquiring financial institutions 20, the card association networks 30, and/or the issuing financial institutions 40 may control the tokenization routing database in order to assign and manage routing instructions for tokenization across the payment processing industry. The tokenization routing database 32 may be populated with the tokens and the corresponding issuing financial institutions 40 to which transactions associated with the tokens should be routed. However, in some embodiments no customer account information would be stored in this tokenization routing database 32, only the instructions for routing particular tokens may be stored.

Once the token and transaction details are routed to the issuing financial institution 40, the issuing financial institution 20 determines the user account associated with the token through the use of the token account database 42. The financial institution determines if the funds are available in the user account for the transaction and if the transaction information meets other limits by comparing the transaction information with the limits associated with the token, the user account associated with the token, or other limits described herein. If the transaction meets the limits associated with the token or user account, then the issuing financial institution 20 allows the transaction. If the transaction information does not meet one or more of the limits, then the issuing financial institution 20 denies the transaction. The issuing financial institution sends a notification of the approval or denial of the transaction back along the channels of the transaction processing system to the merchant 10, which either allows or denies the transaction.

The embodiment illustrated in FIG. 1B allows the user and the financial institution to shield the user's account number and other user information from all of the entities in the payment processing system because the merchant 10, acquiring merchant bank 20, payment association networks 30, or other institutions in the payment processing system only use the token and/or other shielded user information to process the transaction. Only the issuing financial institution 40 has the actual account number of the user 2.

FIG. 1C illustrates another embodiment of the token system process 1, in which the user 2 may utilize a payment device 4 (or payment instrument over the Internet) to enter into transactions with a merchant 10 utilizing a token instead of a user account number and/or other user account information. As illustrated in FIG. 1C, the user 2 may have one or more tokens associated with the payment device 2, the one or more digital wallets, or one or more user accounts within the digital wallets. The one or more tokens may be stored in the user's payment device 4 (or within the digital wallet), or stored on a cloud or other service through the issuing financial institution 40 or another institution. The user 2 may set up the digital wallet by communicating with the issuing financial institution 40 (e.g., the user's financial institution) and/or the merchant 10 to request a token for the payment device 4, either for the payment device 4 itself, for the one or more digital wallets stored on the payment device 4, or for user accounts within the digital wallet. The financial institution 40 may have a dedicated group of tokens that are associated with a specific merchant, and as such the merchant 10 and the issuing financial institution 40 may communicate with each other to provide one or more tokens to the user 2 that may be specifically associated with the merchant 10. For example, the issuing financial institution may provide a set of tokens to “merchant 1” to associate with “wallet 1” that may be used by one or more users 2. As such “Token 10” may be associated with “wallet 1” and be specified only for use for transactions with “merchant 1.”

The merchant 10 may provide the specific tokens from the financial institution 40 to the user 2, while the financial institution 40 may store the user account information with the token provided to the user 2. The financial institution may communicate directly with the user 2, or through the merchant 10 in some embodiments, in order to associate the token with the user 2. Since the merchant 10 provides, or is at least notified by the financial institution 40, that a specific token, or groups of tokens, are associated with a specific issuing financial institution 40, then the merchant 10 may associate routing information and transaction information with the token when the user 2 enters into a transaction with the merchant 10 using the token.

The merchant 10 passes the token (and potentially other user account information), routing information, and transaction information to the acquiring financial institution 20 using the traditional payment processing channels. The acquiring financial institution 20, in turn, passes the token (and potentially other user account information) and transaction information to the issuing financial institution 40 directly, or indirectly through the payment association networks 30 using the routing information. The issuing financial institution 40 accesses the token and account database 42 to identify the user account associated with the token and determines if the transaction information violates any limits associated with the token or the user account. The issuing financial institution 40 then either approves or denies the transaction and sends the approval or denial notification back through the payment processing system channels to the merchant 10, which then notifies the user 2 that the transaction is allowed or denied.

As is the case with the token system process 1 in FIG. 1B, the token system process 1 in FIG. 1C allows the user 2 and the financial institution 40 to shield the user's account number and other user information from all of the entities in the payment processing system because the merchant 10, acquiring merchant bank 20, payment association networks 30, or other institutions in the payment processing system only use the token and/or other shielded user information to process the transaction. Only the issuing financial institution 40 has the actual account number of the user 2.

The embodiments of the invention illustrated in FIGS. 1A through 1C are only example embodiments of the invention, and as such it should be understood that combinations of these embodiments, or other embodiments not specifically described herein may be utilized in order to process transactions between a user 2 and merchant 10 using one or more tokens as a substitute for user account numbers or other user account information, such that the merchant 10, or other institutions in the payment processing system do not have access to the actual user accounts or account information.

As briefly discussed above, if the issuing financial institution 40 creates the digital wallet not only does the issuing financial institution 40 receive transaction information along the normal processing channels, but the financial institution 50 may also receive additional transaction information from the user 2 through the digital wallet using the application program interfaces (APIs) or other applications created for the digital wallet. For example, geographic location information of the user 2, dates and times, product information, merchant information, or any other information may be transmitted to the issuing financial institution 40 through the APIs or other applications to the extent that this information is not already provided through the normal transaction processing channels. This additional transaction information may assist in determining if the transactions meet or violate limits associated with the tokens, user accounts, digital wallets, or the like.

Alternatively, if the merchant 10 or another institution, other than the issuing financial institution 40, provides the digital wallet to the user 2, the issuing financial institution 40 may not receive all the transaction information from the traditional transaction processing channels or from the digital wallet. As such, the issuing financial institution 40 may have to receive additional transaction information from another application associated with the user 2 and compare the transaction information received through the traditional channels in order to associate the additional information with the transaction. In other embodiments, the issuing financial institutions 40 may have partnerships with the merchants 10 or other institutions to receive additional transaction information from the digital wallets provided by the merchants or other institutions when the users 2 enter into transactions using the digital wallets.

Moreover, when there is communication between the digital wallets of the users 2 and the issuing financial institution 40 or another institution, transactions in which the user 2 may enter may be pre-authorized (e.g., pre-qualified) to determine what accounts (e.g., tokens) may be used to complete the transaction, without having to arbitrarily choose an account for the transaction. In the case when there are multiple digital wallets or multiple accounts, the account that is pre-authorized or the account that provides the best rewards may be automatically chosen to complete the transactions.

Additional embodiments of the invention will now be described in further detail in order to provide additional concepts and examples related to how tokens may be utilized in these illustrated token system processes 1 or in other token system processes not specifically described in FIGS. 1A through 1C.

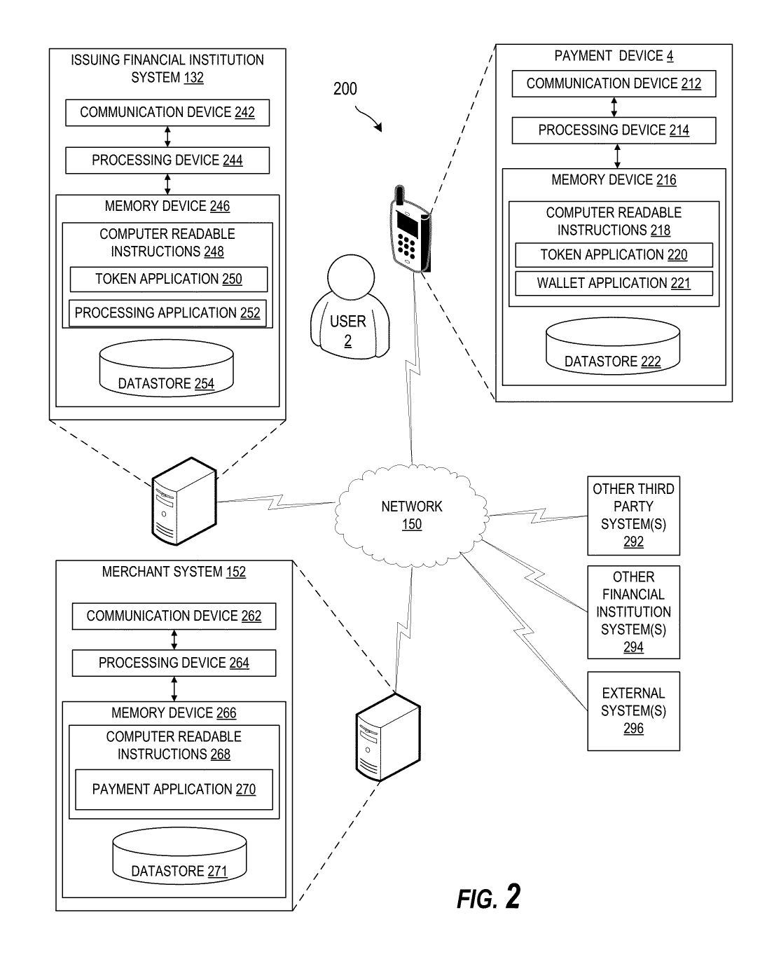

Referring now to FIG. 2, a block diagram illustrates an environment 200 for providing, managing, funding, and processing tokens. The environment 200 includes the payment device 4 of FIG. 1 as well as a merchant system 152 of the merchant 10 and an issuing financial institution system 132 of the issuing financial institution 40. The environment 200 further includes one or more other third party systems 292 (e.g., the system of the tokenization service 50 or systems of a partner, agent, or contractor associated with the issuing financial institution system provider and/or a financial institution), one or more other financial institution systems 294 (e.g., the system of the acquiring financial institution 20, the systems of the payment association networks 30, or systems of a credit bureau, third party banks, and so forth), and one or more external systems 296. The systems and devices communicate with one another over the network 150 and perform one or more of the various steps and/or methods according to embodiments of the disclosure discussed herein. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet.

The payment device 4, the merchant system 152, and the issuing financial institution system 132 each includes a computer system, server, multiple computer systems and/or servers or the like. The issuing financial institution system 132, in the embodiments shown has a communication device 242 communicably coupled with a processing device 244, which is also communicably coupled with a memory device 246. The processing device 244 is configured to control the communication device 242 such that the issuing financial institution system 132 communicates across the network 150 with one or more other systems. The processing device 244 is also configured to access the memory device 246 in order to read the computer readable instructions 248, which in some embodiments includes a token application 250 and processing application 252. The memory device 246 also includes a datastore 254 or database for storing pieces of data that can be accessed by the processing device 244.

As used herein, a “processing device,” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 214, 244, or 264 may further include functionality to operate one or more software programs based on computer-executable program code thereof, which may be stored in a memory. As the phrase is used herein, a processing device 214, 244, or 264 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “memory device” generally refers to a device or combination of devices that store one or more forms of computer-readable media and/or computer-executable program code/instructions. Computer-readable media is defined in greater detail below. For example, in one embodiment, the memory device 246 includes any computer memory that provides an actual or virtual space to temporarily or permanently store data and/or commands provided to the processing device 244 when it carries out its functions described herein.

The payment device 4 includes a communication device 212 and communicably coupled with a processing device 214, which is also communicably coupled with a memory device 216. The processing device 214 is configured to control the communication device 212 such that the payment device 4 communicates across the network 150 with one or more other systems. The processing device 214 is also configured to access the memory device 216 in order to read the computer readable instructions 218, which in some embodiments includes a token application 220 and a wallet application 221. The memory device 216 also includes a datastore 222 or database for storing pieces of data that can be accessed by the processing device 214.

The merchant system 152 includes a communication device 262 communicably coupled with a processing device 264, which is also communicably coupled with a memory device 266. The processing device 264 is configured to control the communication device 262 such that the merchant system 152 communicates across the network 150 with one or more other systems. The processing device 264 is also configured to access the memory device 266 in order to read the computer readable instructions 268, which in some embodiments include a payment application 270. The memory device 266 also includes a datastore 271 or database for storing pieces of data that can be accessed by the processing device 264.

In some embodiments, the token application 220 and wallet application 221 and the payment application 270 interact with the token application 250 and the processing application 252 to receive token requests, generate tokens, select tokens, provide tokens, set parameters and account associations for the tokens, track token transactions, authenticate tokens, analyze transaction data, process transactions, and calculate transaction data.

The applications 220, 221, 250, 252, and 270 are for instructing the processing devices 214, 244 and 264 to perform various steps of the methods discussed herein, and/or other steps and/or similar steps. In various embodiments, one or more of the applications 220, 221, 250, 252, and 270 are included in the computer readable instructions stored in a memory device of one or more systems or devices other than the systems 152 and 132 and the user's capture device 4. For example, in some embodiments, the application 220 is stored and configured for being accessed by a processing device of one or more third party systems 292 connected to the network 150. In various embodiments, the applications 220, 221, 250, 252, and 270 stored and executed by different systems/devices are different. In some embodiments, the applications 220, 221, 250, 252, and 270 stored and executed by different systems may be similar and may be configured to communicate with one another, and in some embodiments, the applications 220, 221, 250, 252, and 270 may be considered to be working together as a singular application despite being stored and executed on different systems.

In various embodiments, one of the systems discussed above, such as the issuing financial institution system 132, is more than one system and the various components of the system are not collocated, and in various embodiments, there are multiple components performing the functions indicated herein as a single device. For example, in one embodiment, multiple processing devices perform the functions of the processing device 244 of the issuing financial institution system 132 described herein. In various embodiments, the issuing financial institution system 132 includes one or more of the external systems 296 and/or any other system or component used in conjunction with or to perform any of the method steps discussed herein. For example, the issuing financial institution system 132 may include a financial institution system, an information technology system, and the like.

In various embodiments, the issuing financial institution system 132, the merchant system 152, and the payment device 4 and/or other systems may perform all or part of a one or more method steps discussed above and/or other method steps in association with the method steps discussed above. Furthermore, some or all the systems/devices discussed here, in association with other systems or without association with other systems, in association with steps being performed manually or without steps being performed manually, may perform one or more of the steps of method 300, the other methods discussed below, or other methods, processes or steps discussed herein or not discussed herein.

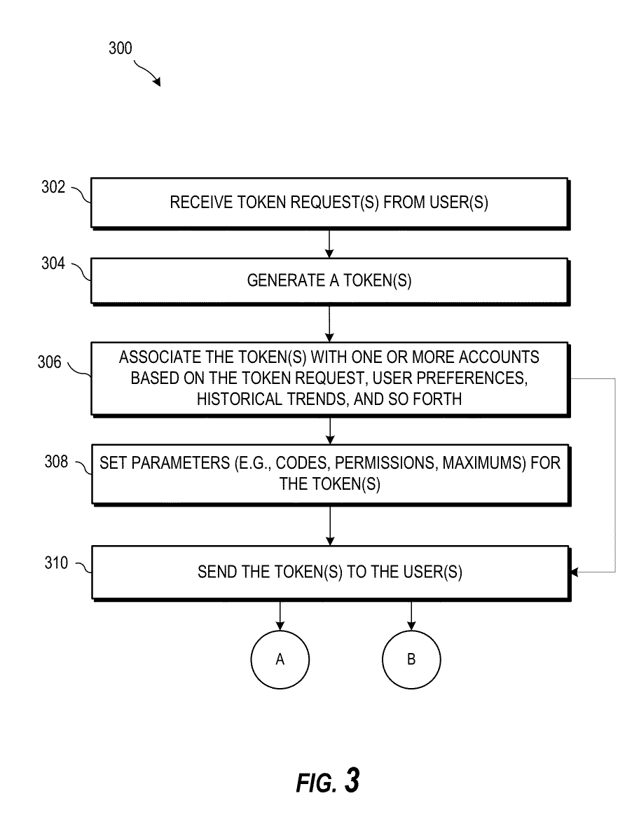

FIG. 3 illustrates a flowchart providing an overview of a process 300 for providing flexible funding account token associations. One or more devices, such as the one or more computing devices and/or one or more other computing devices and/or servers of FIGS. 1A-1C and FIG. 2, can be configured to perform one or more steps of the process 300 described below. In some embodiments, the one or more devices performing the steps are associated with a financial institution. In other embodiments, the one or more devices performing the steps are associated with a merchant, business, partner, third party, credit agency, account holder, and/or user.

As illustrated at block 302, a token request is received from a user. The token request can include one or more requests for one or more tokens. The user can include one or more financial institution customers, account holders, agents of the user, employers of the user, employees, of the user, and the like. For example, an employer may submit the token request so that a single funding source (e.g., the employer's account) can be used to distribute a shared token or multiple token to one or more employees. In other cases, an account holder may simply want to associate their credit card or debit card with one or more token to fund the token. The token request may contain rules, guidelines, and restrictions regarding the token itself, the use of the token, the funding of the token, and the like.

In some embodiments, the token request comprises the number of tokens to be generated, token user permissions, and token use restrictions. In some cases, the number of tokens requested may be based on future intended use, whether the tokens will be single use tokens or multi-use tokens, the number of people to be using the tokens, and the number of accounts to be associated with the tokens. For example if a token is to be associated with a single account, but used by more than one person, the user may request that the multiple tokens be issued. In other examples, the user may request that a single token be issued and shared by multiple users. Further, a single token can be associated with or otherwise funded by a single account or funded by multiple accounts. In some cases, the user may set us specific rules regarding switching accounts source funding as explained in more detail below.

Exemplary data that can be included in the token request includes any data needed in order for the system of process 300 to generate the tokens, and includes account numbers, account terms, user preferences, user identifications, user contact information, proof of identity, and the like.

The token request may be submitted via an online banking account, a mobile application, a digital wallet, a third party web portal, and the like. For example, the user may access an online token service or a mobile token application to request a token. The user can also include the token in a mobile wallet application.

As illustrated at block 304, the token is generated. The token can comprise one token or multiple tokens. In some embodiments, at least a portion of the token comprises a randomized string of numbers or other symbols. The token can include a portion of an account number, an internal code corresponding to a type of account or type of token, or any combination of symbols. For example, the token can include symbols such as numbers, letters, punctuation marks, and geometric shapes; logos; graphics; codes; and any combination thereof. The token can be configured to be compatible with point of sales devices, merchant systems, and the like. For example, the token can include a 16-digit number corresponding to an account number. In other cases, the token can be in the form of QR code, bar code, a tag, a string of symbols of any length, and the like.

In some embodiments, the generated token comprises new data. For example, the generated token may include a new string of random alphanumeric symbols. In other embodiments, the generated token comprising at least a portion of an existing or previously generated token. For example, the system of process 300 may issue a series of tokens over an extended time period that include the 3^{rd} through 7^{th} numbers of the user's credit card account at the end of a string of random symbols. In such cases, the issued tokens will have the same format and have the same string of five numbers at the end portion of each of the tokens, but the tokens will also include different strings of random symbols such that each token is unique. In other examples, tokens generated during the month of October may have the numbers “10” or the letters “oct” at the beginning portions of each token, but have different symbol in the middle or end portions of the tokens. In still other examples, the generated token may include a duplicate of a previously generated token. For example, if a user loses access to a token or if a single token is shared among multiple users, the system may generate duplicates or exact copies of previously generated tokens. In some cases, the system may further add an additional designator to indicate the version of the token, that the token is a duplicate, or that the token is shared. In cases where the token is shared, the system may further include a designator identifying the user associated with the token such as the user's initials or portions of the use's employee ID.

As illustrated at block 306, the token is associated with one or more accounts. In some embodiments, the association of the token and the one or more accounts is based on the token request, user preferences, historical trends, and the like. The token-account association provides a means for funding the tokens such that when the token is used, the account associated with the token is debited or credited. The system can prompt the user for input including account numbers and token associations. In other cases, the system may identify previous tokens requested by the user and identify the accounts associated with the previous tokens.

As illustrated at block 308, parameters are set for the tokens. The parameters include restrictions, permissions, thresholds, rules, and categories related to token users, token utilization, and types of tokens. In some embodiments, the token parameters includes merchant codes, item codes (e.g., product SKUs or other identifiers), internal codes for identifying categories of products or merchants, and other codes. Such codes may be used to restrict or limit tokens use to transactions that include or are associated with certain merchant, certain types of products, or a certain number of products. In additional embodiments, the token parameters include permissions for token users. For example, specific users, types of users, or groups of users may be granted permission to access and utilize tokens. In some cases, a single user such as the token requester, the account holder of the accounts associated with the tokens, or an agent of the user may be the only individual authorized to use or make changes to the token. In cases where a token is shared, certain assigned users may be given limited authorization while others may be given broader permissions. For example, senior management may be allowed to use the token at any time and for a broad range of purposes, while a lower level employee may only be allowed to use the token during weekdays for assigned work projects. Moreover senior management may further be allowed to make changes to token funding sources, while other users may only be given non-administrative permissions.

In still further embodiments, the token parameters include thresholds, ranges, and percentages for transaction amounts. For example, the token parameters can include a maximum transaction amount. The maximum transaction amount can be based on total transaction amounts, partial transaction amounts, and the like. For example the maximum transaction amount may be limited to only a portion of the total transaction amount such as the total amount associated with certain items or certain categories of products. The system can identify certain products that fall within a specific price range or category; products that have discounts; or products that are part of a reward program, and then calculate the total amount for such identified products and compare them to the token parameters.

As illustrated at block 310, the token is sent to the user. The token may be provided to the user via any form of communication such as voice, text, or email. The token can also be sent to a user's online account or transmitted to a mobile application such as a digital wallet or mobile online account. In cases where there are multiple users, the token (or tokens) may be sent to a lead user so that the lead user can then disseminate the token to the appropriate users. In some cases, the timing of the dissemination of the token may be based on the identity of the user, whether the token is a single use or multi-use token, or the expiration date of the token. The token may be provided to the user instantaneously in cases where the user is at or near a point of sale or where the token is set to expire within a day or within a few hours. In other cases, the token may be generated instantaneously but not sent to certain users until the token is available for use. For example, some tokens may not become enabled instantaneously but may have a use range for a future period of time. If a user anticipates traveling during the upcoming week, the token request may indicate that the token become activated during the time the user is traveling.

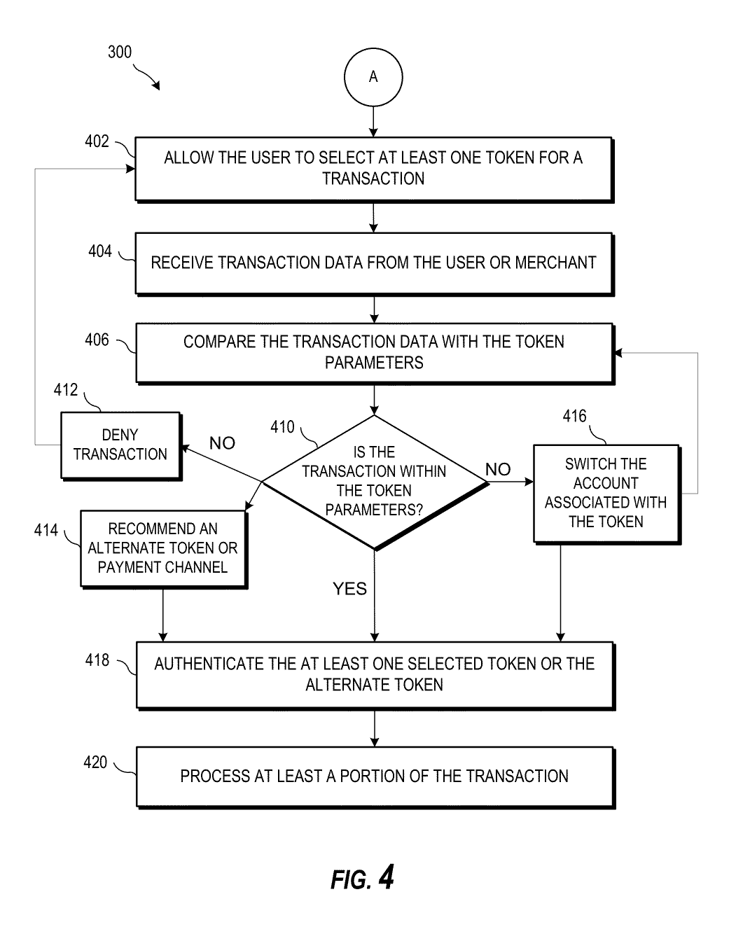

Referring now to FIG. 4, the process 300 is further illustrated. As illustrated at block 402, the user is allowed to select at least one token for a transaction. Although the embodiments herein describe the transaction as a purchase, it will be understood that other types of transactions may be used in the process 300 such as automated teller machine (ATM) transactions, deposits, withdrawals, automatic bill pay, and so forth. The user may select the token at a point of sale using a mobile application such as a digital wallet or a mobile banking application. In other examples, the user may set up a default token for certain transactions based on the merchant, the purchase items, and the like. When a user enters a store, for example, a mobile application may automatically detect that the user is in the store using GPS data generated by a mobile device of the user and select a merchant token associated with the store.

In other embodiments, the system provides a token recommendation to the user. The token recommendation can be based on token types (single use or multi-use), token funding sources, permissions, token use restrictions (e.g., restricted by purchase items, merchants, and so forth), and the like. For example, the system may recommend tokens set to expire in the very near futures rather than tokens that have a longer period of use. In other examples, the system may determine that certain tokens are funded by a credit card account associated with reward programs or that have a certain credit maximums and may prioritize tokens or make suggestions based on this information as well. The system can also look to the user's previous token selections in determining the token recommendation. For example, if the user has chosen tokens about to expire within a limited period (e.g., in the upcoming few days) over tokens associated with certain accounts or merchants 75% of the time during the previous 3 months, the system may recommend tokens set to expire that day even if other tokens would offer more favorable terms for the user (e.g., greater discounts). In still further example, the system may recommend that a user not select certain tokens if a penalty or cost may be incurred as a result of using the token. In further embodiments, the token recommendation is based on token parameters as described below.

As illustrated at block 404, transaction data is received from the user or a merchant. In one example, the user provides the token to the merchant (e.g., via NFR technology, wireless technology, and so forth), and the merchant then sends the token and the transaction data to a payment-processing network or other third party. The transaction data includes merchant codes, product codes, transaction amounts, transaction times and dates, and the like. In other examples, the user inputs a transaction amount and/or other transaction data in a digital wallet and selects a token. The system may determine if the token can be used for the transaction before allowing the user to provide the token to the merchant.

As illustrated at block 406, the transaction data is compared with the token parameters. In some embodiments, the transaction data is pre-configured by the system. The system of process 300 identifies certain purchase items or categories of items and then calculates transaction amounts or percentages in order to streamline the data and token parameter comparison. For example, if 51% of the transaction amount must be food items, the systems can identify food items, calculate a total amount of such items, and then calculate the percentage of the total amount. In other examples, the merchant codes provided in the transaction data or the GPS data of the user's mobile device may be used to determine the geographic location of the transaction. The geographic location may be then used to determine other merchants in the geographic location, determine other ATM machines (e.g., in cases where the transaction is a money withdrawal), banking centers, and so forth.

In other examples, the system may compare the transaction data directly without pre-calculating the data, or may retrieve additional data such as reward program data for the account funding the token, credit maximum account balances, and the like.

As illustrated at decision block 410, it is determined whether the transaction is within the token parameters or otherwise compliant with the requirements of the token parameters based on the comparison.

As illustrated at block 412, the transaction is denied if the transaction does not comply with the token parameters. In some embodiments, at least a portion of the process 300 is repeated. For example, the user may select another token. In other cases, a portion of the transaction may be approved based on the available balance of the funding source of the token or if only a portion of the transaction complies with the transaction parameters. For example, if the total transaction amount is $150 and the account balance of the account funding the token is $200, only $100 of the transaction may be approved if the token parameters require that the account balance remain above a certain minimum amount.

Even if the transaction is within the token parameters, the system may deny the transaction. For example, if it would be better for the selected token to be used at other merchants and other ATM machines within the geographic vicinity of the transaction, the system may deny the transaction for the selected token. In other examples, the transaction may be denied if the use of the token would incur a transaction cost.

As illustrated at block 414, an alternate token or payment channel is recommended to the user. The alternate token may be an existing token or a potentially new token. If the user has multiple tokens, the system may provide a recommendation for another token in situations where the entire transaction or a portion of the transaction cannot be processed using the token the user originally selected. The alternate token may be used in place of or in addition to the selected token. If the user does not have an alternate token that can be used to process the transaction because the user has only a single token or if the other tokens available to the user do not comply with the token parameters, the system may create a new token or prompt the user to create a new token. In still other cases, the system may recommend that another payment channel such as a credit card, debit card, or other payment method be used.

As illustrated at block 416, the account associated with the token is switched to another account if it is determined that the transaction is not within the token parameters. For example, some tokens may be funded by a third party account, such as the user's employer's account, and the system may determine that those tokens cannot be used to fund personal or unapproved transactions. In such cases, the system can automatically switch or prompt the user to switch the funding source from the third party account to the user's personal account so that the token can be used. Further, if a first account has reached its credit maximum, has a limited amount of funds, is beyond or near its expiration date, has a high interest rate, or is otherwise undesirable or unavailable, the token funding can be switched to a second account. In still other embodiments, the user chooses to switch the account associated with token from a first account to a second account. For example, a user may decide to switch the accounts in real time at a point of sale. Upon switching the association of the token from a first account to a second account, the process 300 can proceed to repeat transaction data-parameter comparison and so forth.

As illustrated at block 418, the at least one selected token or alternate token is authenticated. In some embodiments, the system compares the token to stored token data (e.g., the data stored in datastore 254 of FIG. 2). For example, the system can store the token data in a database when each token is generated and may also store other data such as user account data, funding source data, permission, and other information for mapping such information to each stored token. If a match is found between the token and stored token data, the at least one selected token is authenticated.

As illustrated at block 420, the transaction is processed. The system can authorize the transaction, provide the transaction to a third party, move transaction amounts between accounts, provide reports, and the like. Details regarding transaction processing is discussed above with regard to FIGS. 1A-1C.

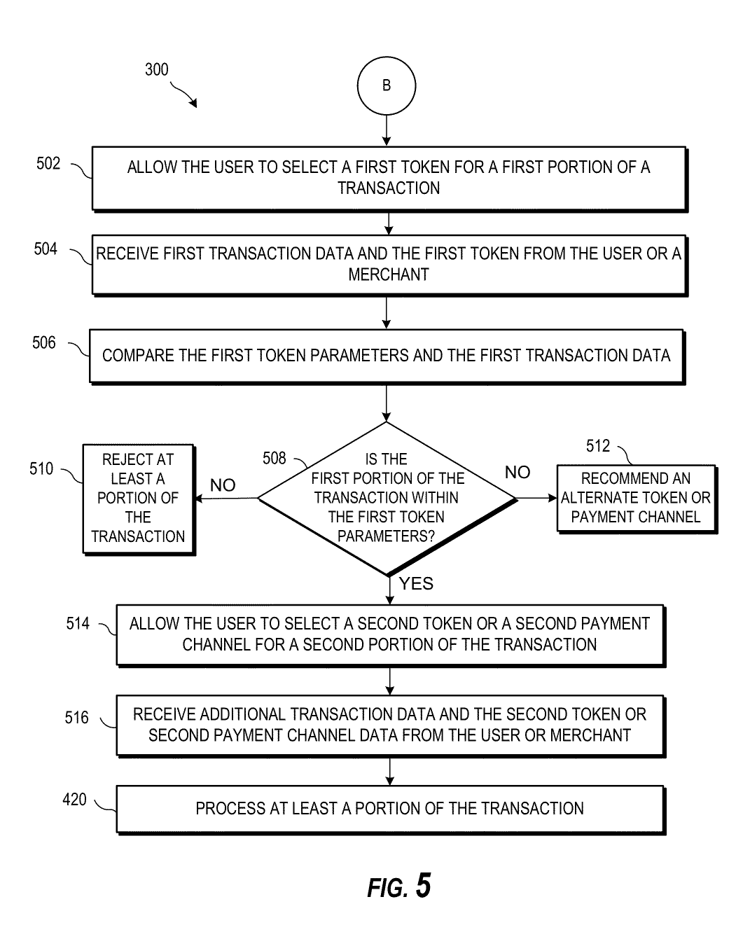

Referring now to FIG. 5, the process 300 is further illustrated. As illustrated at block 502, the user is allowed to select a first token for a first portion of a transaction. The user may select an established token, create a new token, or select a token recommended by the system. The first portion of the transaction can include certain transaction items, a percentage of the purchase items or the total amount of the transaction, a category of items grouped by item type (e.g., items qualifying under a program, discounted items, and so forth), and the like. The first portion of the transaction may be an entire purchase amount and exclude a cash back amount. If a user selects a token funded by a debit card, for example, such tokens may be used to make purchases and cash withdrawals.

As illustrated at block 504, first transaction data and the first token is received from the user or a merchant. The first transaction data, in some embodiments, only includes data pertinent to the first portion of the transaction. For example, if the first portion of the transaction comprises certain products, then amounts, product descriptions, and codes for the certain products may be included in the first transaction data. In other embodiments, the first transaction data includes the entire transaction data.

As illustrated at block 506, the first token parameters and the first transaction data are compared. As described hereinabove, the system may first configure the transaction data (e.g., calculate totals or subtotals, categorize, and so forth) before the comparison, or the system may simply compare the first token parameters and the first transaction data directly.

As illustrated at decision block 508, it is determined whether the first portion of the transaction is within or otherwise compliant with the first token parameters. The first token parameters can include parameters that are specific to the first token and/or parameters that are common to all of the user's tokens. For example, the user may have several single use tokens that are each associated with a checking account, but that have different expiration dates. In other examples, the first token may be a multi-use token that is shared among multiple users. If the first token parameters limits the use of the token to a certain number of uses or amounts for a time period (e.g., a day), the first token may fall outside of the first token parameters if the token has already been used by other users during the designated time period.

As illustrated at block 510, at least a portion of the transaction is rejected if the first portion of the transaction is not within the first token parameters. The entire transaction or only a portion of the transaction can be rejected. For example, only the first portion of the transaction may be rejected where only a portion of the transaction data was received. The system may provide a rejection message to the merchant on a point of sale display, or the system may provide the rejection message to the user via a digital wallet. The rejection message can state that a portion or the entire transaction is rejected or declined, and can further provide additional information such as the reasons for the transaction rejection (e.g., funds unavailable, token expired, and so forth) or further action that may be taken. The rejection message may include, for example, a dial-in number for talking with an associate, directions to a local banking center, or the message may provide a recommendation for an alternate token as discussed below.

As illustrated at block 512, an alternate token or payment channel is recommended if the first portion of the transaction is not within the first token parameters. As discussed previously, the alternate token may be an existing token or a potentially new token, and the alternate token may be used in place of or in addition to the selected token. In other cases, the system may create a new token or prompt the user to create a new token. In still other cases, the system may recommend that another payment channel such as a credit card, debit card, or other forms of payment be used.

The recommendation can be for a token that can be used for the entire transaction or the recommendation can be for a token that may be used only on the first portion of the transaction. For example, if the first portion of the transaction only comprise 25% of the total amount of the transaction, a token with a low maximum transaction amount may be recommended for the first portion and a token with a higher maximum transaction amount may be recommended for other portions or the entire portion of the transaction. The system can also recommend multiple tokens to cover different portions of the transaction. For example, if the transaction includes food items covered under a government assistance program, is associated with a certain merchant, and is over $250, the system may list the following token recommendations: a token associated with a government issued debit card to pay for the food items eligible under an assistance program (e.g., $25); a credit card associated with the merchant for certain items eligible for a discount (e.g., sale items that total $100), and another token set to expire in the near future to cover the remaining balance (i.e., $125) of the transaction.

As illustrated at block 514, the user is allowed to select a second token or a second payment channel for a second portion of the transaction. In some embodiments, the first portion of the transaction is the same as the second portion of the transaction. For example, if the first portion is not within the first token parameters, the user may be allowed to select a second token for the same portion of the transaction. In other embodiments, the first portion of the transaction is different from the first portion of the transaction. In such cases, the user may select the second token for the second portion to cover another portion of the transaction. In other embodiments, the second portion of the transaction comprises the first portion of the transaction. For example, the second portion can include the first portion of the transaction and an additional portion of the transaction (e.g., the remaining portion of the transaction or less than the remaining portion).

As illustrated at block 516, additional transaction data and the second token or second payment channel data are received from the user or the merchant. The additional transaction data can include portions of the transaction related to the second portion of the transaction. For example, the additional transaction data can include data for the entire transaction, or data for a portion of the transaction that does or does not include the first transaction data.

In some embodiments, the user sends the token to the system. In such embodiments, the system may provide feedback to the user (e.g., an affirmation that the token can be used, recommendation for an alternate token, and so forth). In this way, the user may be provided with some guidance in selecting the token before providing the token to the merchant for payment or processing. In other embodiments, the user provides the token to the merchant and then the merchant provides the token to the system.

As illustrated at block 420, at least a portion of the transaction is processed as described hereinabove. In such cases, the system can authenticate the first token, second token, or other tokens before processing at least a portion of the transaction.

To supplement the present disclosure, this application further incorporates entirely by reference the following commonly assigned patent applications:

| | U.S. patent application | | |
|---|---|---|---|
| Docket Number | Ser. No. | Title | Filed On |
| 6070US1.014033.2138 | 14/196,816 | MANAGED DIGITAL | Concurrently |
| | | WALLETS | Herewith |
| 6071US1.014033.2153 | 14/196,798 | TOKEN | Concurrently |
| | | COLLABORATION | Herewith |
| | | NETWORK | |
| 6071US2.014033.2154 | 14/196,802 | FORMATION AND | Concurrently |
| | | FUNDING OF A | Herewith |
| | | SHARED TOKEN | |
| 6072US1.014033.2151 | 14/196,364 | LIMITING TOKEN | Concurrently |
| | | COLLABORATION | Herewith |
| | | NETWORK USAGE BY | |
| | | USER | |
| 6072US2.014033.2152 | 14/196,373 | LIMITING TOKEN | Concurrently |
| | | COLLABORATION | Herewith |
| | | NETWORK USAGE BY | |
| | | TOKEN | |
| 6073US1.014033.2149 | 14/196,809 | LIMITING THE USE OF | Concurrently |
| | | A TOKEN BASED ON | Herewith |
| | | A USER LOCATION | |
| 6073US2.014033.2150 | 14/196,813 | AUTHORIZING A | Concurrently |
| | | TEMPORARY TOKEN | Herewith |
| | | FOR A USER | Concurrently |
| 6074US1.014033.2148 | 14/196,030 | CONTROLLING | Herewith |
| | | TOKEN ISSUANCE | |
| | | BASED ON EXPOSURE | |
| 6075US1.014033.2146 | 14/196,292 | FLEXIBLE FUNDING | Concurrently |
| | | ACCOUNT TOKEN | Herewith |
| | | ASSOCIATIONS | |
| 6075US2.014033.2147 | 14/196,350 | ACCOUNT TOKEN | Concurrently |
| | | ASSOCIATIONS | Herewith |
| | | BASED ON SPENDING | |
| | | THRESHOLDS | |
| 6076US1.014033.2144 | 14/196,383 | ONLINE BANKING | Concurrently |
| | | DIGITAL WALLET | Herewith |
| | | MANAGEMENT | |
| 6076US2.014033.2145 | 14/196,653 | CUSTOMER TOKEN | Concurrently |
| | | PREFERENCES | Herewith |
| | | INTERFACE | |
| 6076US3.014033.2172 | 14/196,752 | CREDENTIAL | |
| | | PAYMENT | Concurrently |
| | | OBLIGATION | Herewith |
| | | VISIBILITY | |
| 6077US1.014033.2143 | 14/196,919 | PROVIDING | Concurrently |
| | | SUPPLEMENTAL | Herewith |
| | | ACCOUNT | |
| | | INFORMATION IN | |
| | | DIGITAL WALLETS | |
| 6078US1.014033.2142 | 14/196,894 | PROVIDING OFFERS | Concurrently |
| | | ASSOCIATED WITH | Herewith |
| | | PAYMENT | |
| | | CREDENTIALS IN | |
| | | DIGITAL WALLETS | |
| 6078US2.014033.2179 | 14/196,869 | PROVIDING OFFERS | Concurrently |
| | | ASSOCIATED WITH | Herewith |
| | | PAYMENT | |
| | | CREDENTIALS | |
| | | AUTHENTICATED IN | |
| | | A SPECIFIC DIGITAL | |
| | | WALLET | |
| 6079US1.014033.2141 | 14/196,257 | FOREIGN EXCHANGE | Concurrently |
| | | TOKEN | Herewith |
| 6079US2.014033.2173 | 14/196,274 | FOREIGN CROSS- | Concurrently |
| | | ISSUED TOKEN | Herewith |
| 6080US1.014033.2140 | 14/196,545 | DIGITAL WALLET | Concurrently |
| | | EXPOSURE | Herewith |
| | | REDUCTION | |
| 6080US2.014033.2174 | 14/196,460 | MOBILE DEVICE | Concurrently |
| | | CREDENTIAL | Herewith |
| | | EXPOSURE | |
| | | REDUCTION | |
| 6081US1.014033.2139 | 14/196,947 | ATM TOKEN CASH | Concurrently |
| | | WITHDRAWAL | Herewith |
| 014033.002194 | 14/196,034 | RESTORING OR | Concurrently |
| | | REISSUING OF A | Herewith |
| | | TOKEN BASED ON | |
| | | USER | |
| | | AUTHENTICATION | |
| 014033.002195 | 14/196,405 | TOKEN USAGE | Concurrently |
| | | SCALING BASED ON | Herewith |
| | | DETERMINED LEVEL | |
| | | OF EXPOSURE | |

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or teams thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to embodiments of the disclosure in the form disclosed. Many modifications and variations will be apparent to those of ordinary skill in the art without departing from the scope and spirit of embodiments of the disclosure. The embodiment was chosen and described in order to best explain the principles of embodiments of the disclosure and the practical application, and to enable others of ordinary skill in the art to understand embodiments of the disclosure for various embodiments with various modifications as are suited to the particular use contemplated. Although specific embodiments have been illustrated and described herein, those of ordinary skill in the art appreciate that any arrangement which is calculated to achieve the same purpose may be substituted for the specific embodiments shown and that embodiments of the disclosure have other applications in other environments. This application is intended to cover any adaptations or variations of the present disclosure. The following claims are in no way intended to limit the scope of embodiments of the disclosure to the specific embodiments described herein.

What is claimed is:

1. A system for providing token-account associations, whereby the system modifies token-account associations based on various token parameters, the system comprising:
a computer apparatus including a processor and a memory; and
a software module stored in the memory, comprising executable instructions that when executed by the processor cause the processor to:
receive a token request from a user;
generate a token;
associate the token with a first account;
set parameters for the token, the token parameters comprising at least a financial transaction amount maximum;
allow the user to select the token for a financial transaction;
receive transaction data associated with the financial transaction; and
compare the transaction data with the token parameters.

2. The system of claim 1, wherein the executable instructions further cause the processor to:
determine that the transaction amount is above the transaction amount maximum.

3. The system of claim 2, wherein the executable instructions further cause the processor to:
switch the association of the token from the first account to a second account.

4. The system of claim 3, wherein the first account and the second account are different types of accounts.

5. The system of claim 1, wherein the executable instructions further cause the processor to:
determine that the transaction amount is below the transaction amount maximum based on the comparison;
authenticate the token; and
process the transaction.

6. The system of claim 5, wherein the executable instructions further cause the processor to:
recommend an alternate token or payment channel to the user.

7. The system of claim 5, wherein the executable instructions further cause the processor to:
allow the user to select a second token for the transaction.

8. The system of claim 1, wherein the token parameters further comprise product codes and wherein the executable instructions further cause the processor to:
identify items corresponding to the product codes
calculate a total amount for the identified items; and
determine whether the total amount is above or below the transaction amount maximum.

9. The system of claim 1, wherein the transaction amount maximum is based on at least one of user preferences, a spending category, or a type of account.

10. The system of claim 1, wherein the executable instructions further cause the processor to:
associate the token with a mobile wallet application.

11. The system of claim 1, wherein the token is a single-use instrument or a multi-use instrument.

12. A computer program product for providing token-account associations, the computer program product comprising:
a non-transitory computer readable storage medium having computer readable program code embodied therewith, the computer readable program code comprising:
computer readable program code configured to receive a token request from a user;
computer readable program code configured to generate a token;
computer readable program code configured to associate the token with a first account;
computer readable program code configured to set parameters for the token, the token parameters comprising at least a transaction amount maximum;
computer readable program code configured to allow the user to select the token for a financial transaction;
computer readable program code configured to receive transaction data associated with the financial transaction; and
computer readable program code configured to compare the transaction data with the token parameters.

13. The computer program product of claim 12, further comprising computer readable program code configured to determine that the transaction amount is above the transaction amount maximum.

14. The computer program product of claim 13, further comprising computer readable program code configured to switch the association of the token from the first account to a second account.

15. The computer program product of claim 12, further comprising computer readable program code configured to identify items corresponding to the product codes; calculate a total amount for the identified items; and determine whether the total amount is above or below the transaction amount maximum.

16. The computer program product of claim 12, further comprising computer readable program code configured to associate the token with a mobile wallet application.

17. A computer-implemented method providing token-account associations, the method comprising:
receiving, by a processor, a token request from a user;
generating, by a processor, a token;
associating, by a processor, the token with a first account;
setting, by a processor, parameters for the token, the token parameters comprising at least a transaction amount maximum;
allowing, by a processor, the user to select the token for a financial transaction;
receiving, by a processor, transaction data associated with the financial transaction; and
comparing, by a processor, the transaction data with the token parameters.

18. The computer-implemented method of claim 17, further comprising:
determining, by a processor, that the transaction amount is above the transaction amount maximum.

19. The computer-implemented method of claim 17, further comprising:
switching, by a processor, the association of the token from the first account to a second account

20. The computer-implemented method of claim 17, further comprising:
recommending, by a processor, an alternate token or payment channel to the user.
